(19) United States
(12) Patent Application Publication
(10) Pub. No.: US 2020/0364073 A1
(43) Pub. Date: Nov. 19, 2020

(54) MANAGEMENT APPARATUS, HOST APPARATUS, MANAGEMENT METHOD, AND PROGRAM

(71) Applicant: NEC Corporation, Tokyo (JP)

(72) Inventors: Yutaro OBARA, Tokyo (JP); Hajime ZEMBUTSU, Tokyo (JP); Yusuke TAKANO, Tokyo (JP)

(73) Assignee: NEC Corporation, Tokyo (JP)

(21) Appl. No.: 16/766,035

(22) PCT Filed: Sep. 5, 2018
(86) PCT No.: PCT/JP2018/032817

§ 371 Date: May 21, 2020

(30) Foreign Application Priority Data
Nov. 29, 2017 (JP) 2017-228828

(51) Int. Cl. G06F 9/455

(52) U.S. Cl. CPC G06F 9/45558; G06F 2009/45595

(57) ABSTRACT

A management apparatus is provided with: a receiving part configured to receive, from a host apparatus, a creation instruction for a virtual link that connects a first virtual infrastructure on which a VNF is operating and a second virtual infrastructure that is a movement destination of the VNF; a network conversion information management part configured to manage network conversion information for connecting a first network built on the first virtual infrastructure and a second network built on the second virtual infrastructure, via a third network; and a virtual link creation part configured to transmit, based on the creation instruction for the virtual link, the network conversion information to network management apparatuses that respectively manage the first and second networks, and causes the network management apparatuses to create a virtual link which realizes communication between virtual machines configuring the VNF across the first and second virtual infrastructures.

### CROSS-REFERENCE TO RELATED APPLICATIONS

This application is a national stage application of International Application No. PCT/JP2018/032817 entitled “MANAGEMENT APPARATUS, HOST APPARATUS, MANAGEMENT METHOD, AND PROGRAM,” filed on Sep. 5, 2018, which claims the benefit of the priority of Japanese Patent Application No. 2017-228828 filed on Nov. 29, 2017, the disclosures of each of which are hereby incorporated by reference in their entirety.

### BACKGROUND

### Field

Cloud computing (below, the cloud) is a mode of using computing resources on-demand, that are virtualized on a physical resource such as a server. Network Function Virtualization (below, NFV) is known, where network functionality is virtualized and provided in the cloud. NFV is technology that separates hardware (below, HW) and software (below, SW) for various network services operating on heretofore dedicated HW, and operates the SW on virtual infrastructure, using virtualization technology and cloud technology. In this way, operation enhancement and cost reduction are anticipated.

In ETSI NFV, NFV architecture is defined (refer to Non-Patent Literature (NPL) 1). In virtualized network MANO (Management and Orchestration) VIM that manages virtual infrastructure, VNFM that manages VNF that configures a network service and NFVO that controls these are defined. VIM, VNF and VNFM are respective abbreviations of Virtualized Infrastructure Manager, Virtual Network Function, and VNF Manager. VNF is configured by a VNFC (VNF Component), and the VNFC is executed on one VM (Virtual Machine). In the following description “cloud infrastructure” relates to VIM in NFV, and “service” includes network service in NFV.

In the cloud, there exists an orchestrator that controls VM redundancy/multiplexing executing the same processes. In general, this type of orchestrator is provided with functionality to perform dynamic optimization to suit change in auto healing or user requests to deal with malfunctions occurring in cloud infrastructure.

Patent Literature (PTL) 1 discloses a configuration whereby a user can flexibly perform setting of policy when the orchestrator selects a deployment destination for VM or VNF. Specifically, the same publication discloses that at least one of the NFVO and the VIM selects a deployment destination of configuration elements based on selection information (for example, configuration information, selection policy or the like, described later) related to the deployment destination of the configuration elements (for example, VM or the like) of a virtual network.

### [PTL 1]

International Publication No. WO 2016/121879

### [NPL 1]

ETSI GS NFV-MAN 001 V1.1.1 (2014-12) Network Functions Virtualisation (NFV); Management and Orchestration (online) (retrieved on Oct. 5, 2017), Internet <http://www.etsi.org/deliver/etsi_gs/NFV-MAN/001_099/001/01.01.01_60/gs_NFV-MAN001v010101p.pdf>

### SUMMARY

The following analysis is given according to the present disclosure. The NFV described above, in a case where there are multiple VIMs, is implemented based on an open source program known as OpenStack. In OpenStack, upgrades are frequently performed, and when an upgrade is performed it is necessary to restart service. Therefore, when there is an upgrade, a period of no connection of Vi-Vnfm (VIM-VNFM interface)/Nf-Vi (NFVI-VIM interface) occurs.

During this interruption, since MANO (Management and Orchestration) operations with respect to VNF are not possible, when a malfunction in VNF occurs in that period, VNF (healing) by the VIM cannot be implemented, and provision of service to a user may be affected.

Meanwhile, it is assumed that the VIM performs operation without affecting user service (VNF) operating on a virtual infrastructure. Therefore, it is desired to provide a method to implement VIM upgrading without halting user service.

It is an object of the present disclosure to provide a management apparatus, a host apparatus, a management method and a program, which can contribute to reducing the influence of a VIM upgrade when a user service (VNF) is provided using a virtual machine operating on a virtual infrastructure.

According to a first aspect the disclosure provides a management apparatus that is provided with: a receiving part that receives, from a host apparatus, a creation instruction for a virtual link that connects a first virtual infrastructure on which a virtual network function is operating and a second virtual infrastructure that is a movement destination of the virtual network function. The management apparatus is further provided with a network conversion information management part that manages network conversion information for connecting a first network built on the first virtual infrastructure and a second network built on the second virtual infrastructure, via a third network. The management apparatus is further provided with: a virtual link creation part that transmits, based on the creation instruction for the virtual link, the network conversion information to network management apparatuses that respectively manage the first and second networks, and causes the network management apparatuses to create a virtual link which realizes communication between virtual machines configuring the virtual network function across the first and second virtual infrastructures.

According to a second aspect, the disclosure provides a host apparatus that, before halting service of the first virtual infrastructure, transmits a creation instruction for the virtual link to the management apparatus, and causes a virtual machine configuring a virtual network function operating on the first virtual infrastructure, to move to the second virtual infrastructure, to implement healing.

According to a third aspect, the disclosure provides a management method in a management apparatus that includes a network conversion information management part that manages network conversion information for connecting a first network built on a first virtual infrastructure and a second network built on a second virtual infrastructure, via a third network, the method comprising: receiving, from a host apparatus, a creation instruction for a virtual link that connects a first virtual infrastructure on which a virtual network function is operating and a second virtual infrastructure that is a movement destination of the virtual network function; and transmitting, based on the creation instruction for the virtual link, the network conversion information to network management apparatuses that respectively manage the first and second networks, and causing the network management apparatuses to create a virtual link which realizes communication between virtual machines configuring the virtual network function across the first and second virtual infrastructures. The method is associated with a particular mechanism, which is a management apparatus that creates a virtual link in response to an instruction from the host apparatus.

According to a fourth aspect, the disclosure provides a program that causes a computer, installed in a management apparatus that includes a network conversion information management part that manages network conversion information for connecting a first network built on a first virtual infrastructure and a second network built on a second virtual infrastructure, via a third network, to execute processing comprising: receiving, from a host apparatus, a creation instruction for a virtual link that connects a first virtual infrastructure on which a virtual network function is operating and a second virtual infrastructure that is a movement destination of the virtual network function; and transmitting, based on the creation instruction for the virtual link, the network conversion information to network management apparatuses that respectively manage the first and second networks, and causing the network management apparatuses to create a virtual link which realizes communication between virtual machines configuring the virtual network function across the first and second virtual infrastructures. It is to be noted that this program may be recorded on a computer-readable (non-transitory) storage medium. That is, the present disclosure may be embodied as a computer program product.

The meritorious effects of the present disclosure are summarized as follows.

According to the present disclosure, it is possible to reduce an influence of a VIM upgrade when a user service (VNF) is provided using a virtual machine operating on a virtual infrastructure. In other words, the present disclosure converts the apparatus described in Background into an apparatus which can reduce the influence of a VIM upgrade when a user service (VNF) is provided using a virtual machine operating on a virtual infrastructure.

### BRIEF DESCRIPTION OF THE DRAWINGS

FIG. 1 is a diagram illustrating a configuration of an example embodiment of the present disclosure.

FIG. 2 is a diagram illustrating NFV architecture.

FIG. 3 is a diagram showing a configuration of a first example embodiment of the present disclosure.

FIG. 4 is a functional block diagram showing a configuration of a WIM in the first example embodiment of the disclosure.

FIG. 5 is a diagram showing an example of network conversion information held by the WIM in the first example embodiment of the disclosure.

FIG. 6 is a sequence diagram representing operations of the first example embodiment of the disclosure.

FIG. 7 is a diagram for illustrating operations of the first example embodiment of the disclosure.

FIG. 8 is a sequence diagram representing operations of a second example embodiment of the disclosure.

FIG. 9 is a diagram showing a configuration of a third example embodiment of the disclosure.

FIG. 10 is a sequence diagram representing operations of the third example embodiment of the disclosure.

FIG. 11 is a diagram showing a configuration of a computer functioning as a WIM in respective example embodiments of the disclosure.

### PREFERRED MODES

First, a description is given of an outline of example embodiments of the present disclosure, making reference to the drawings. It is to be noted that reference symbols in the drawings attached to this outline are added to respective elements for convenience as examples in order to aid understanding, and are not intended to limit the present disclosure to modes illustrated in the drawings. Connection lines between blocks in the diagrams referred to in the following description include both unidirectional or bidirectional. Unidirectional arrows schematically show flow of main signals (data), but do not exclude bidirectionality. Ports and interfaces are present at input output connection points of respective blocks in the diagrams, but illustrations thereof are omitted.

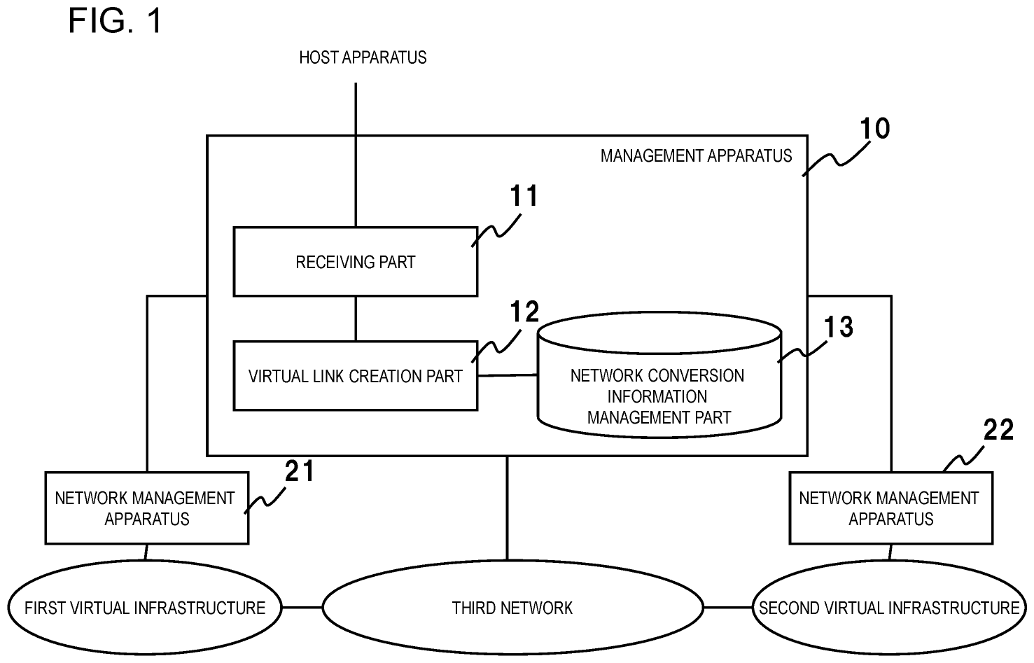

The present disclosure, in an example embodiment thereof as shown in FIG. 1, may be implemented as a management apparatus 10 provided with a receiving part 11, a network conversion information management part 13 and a virtual link creation part 12. More specifically, the receiving part 11 receives, from a host apparatus, a creation instruction for a virtual link that connects a first virtual infrastructure on which a virtual network function is operating and a second virtual infrastructure that is a movement destination of the virtual network function.

The network conversion information management part 13 manages network conversion information for connecting a first network built on the first virtual infrastructure and a second network built on the second virtual infrastructure, via a third network.

The virtual link creation part 12 transmits, based on the creation instruction for the virtual link, the network conversion information to network management apparatuses 21, 22 that respectively manage the first and second networks, and causes the network management apparatuses to create a virtual link which realizes communication between virtual machines configuring the virtual network function across the first and second virtual infrastructures.

By employing the abovementioned configuration, it is possible to provide a configuration that is minimally affected by a VIM upgrade when a user service (VNF) is provided using a virtual machine operating on a virtual infrastructure. A reason for this is that the configuration employed creates a virtual link to realize communication between virtual machines configuring a virtual network function across the first and second virtual infrastructures, based on the creation instruction for the virtual link from the host apparatus.

### <First Example Embodiment>

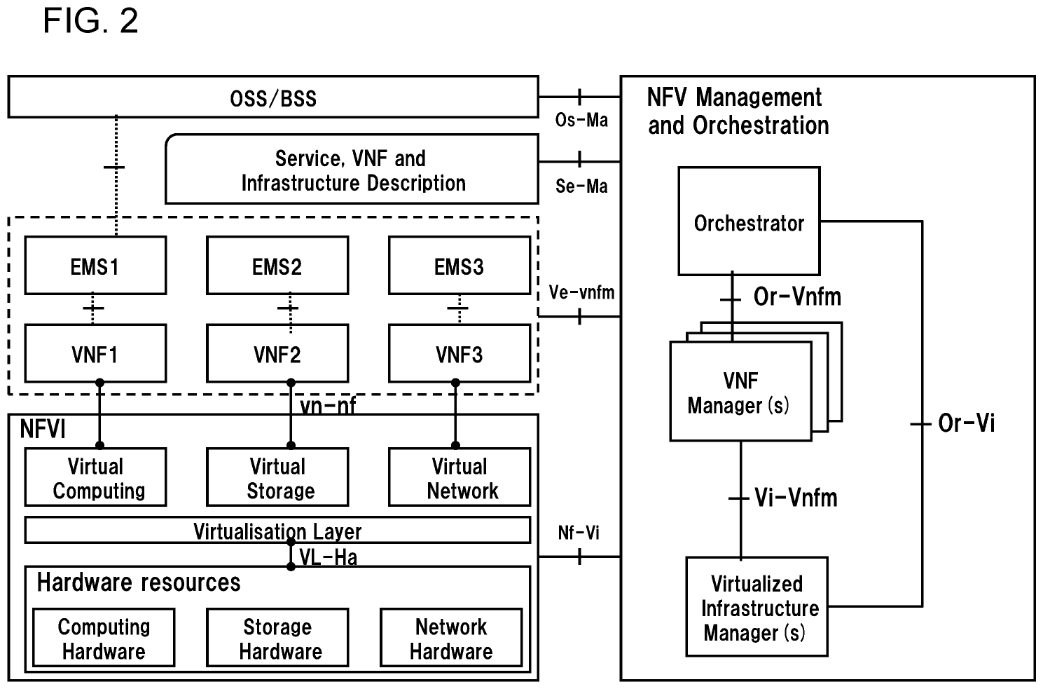

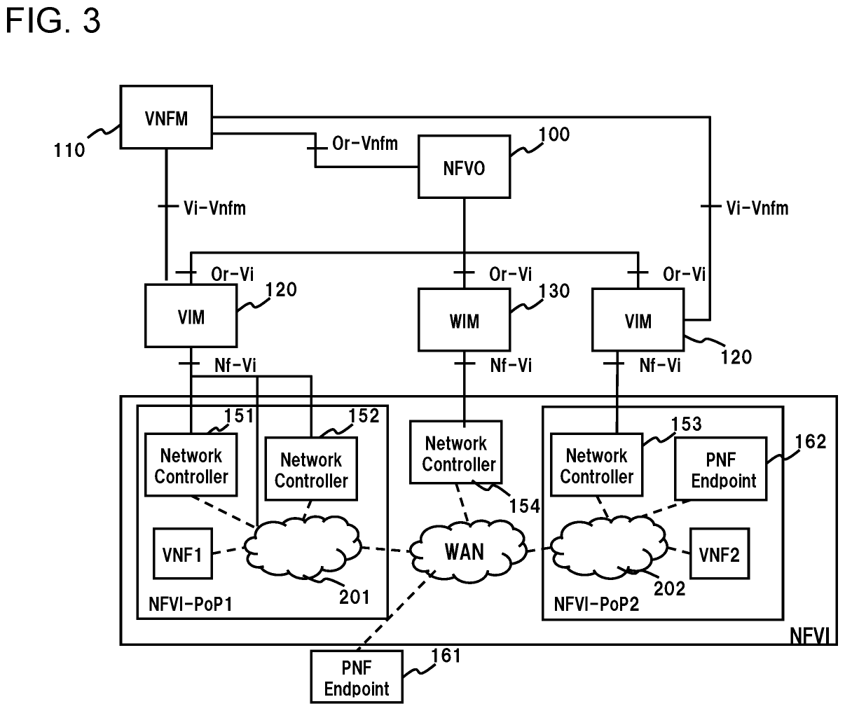

Next, a detailed description is given concerning a first example embodiment of the present disclosure, making reference to the drawings. In the present example embodiment below a description is given of an NFV architecture as shown in FIG. 2. In this type of configuration as shown in FIG. 3, with the initiative of an NFVO 100 (equivalent to the Orchestrator in FIG. 2) or a VNFM 110, being a host node of a VIM 120, the VNF (for example, VNF1 in FIG. 3) on an NFVI managed by the VIM 120 is moved to NFVI (for example, NFVI-PoP2 in FIG. 3) managed by another VIM. In this way, with regard to a movement origin VIM 120 a state is realized wherein an upgrade is possible with no effect on VNF service (below, the movement origin VIM is referred to as SourceVIM, and the movement destination VIM is referred to as TargetVIM. The VIM 120 is equivalent to the abovementioned virtual infrastructure management part).

FIG. 3 is a diagram showing a configuration of the first example embodiment of the present disclosure. FIG. 3 shows a configuration in which 2 NFV architectures shown in FIG. 2 are connected via a WAN (equivalent to a third network). NFVI is configured to include NFVI-PoP (Point of Presence) 1 and NFVI-PoP (Point of Presence) 2. One or more Network Controllers 151, 152, 153 are disposed at each of the NFVI-PoP1 and NFVI-PoP2. The Network Controllers 151, 152, 153 are realized by SDN (Software Defined Network) controllers. The Network Controllers 151, 152, 153 can control communication between VMs configuring VNF1, VNF2 or communication between VM and PNF (Physical Network Function) Endpoints 161, 162.

When the abovementioned VNF is moved, with regard to VMs within the VNF, it is necessary to continue communication among VMs. Therefore, in the present example embodiment as shown in FIG. 3, an apparatus known as a WIM (WAN Infrastructure Manager) is disposed as a host of Network Controller 154 that manages the WAN. In the process of moving the abovementioned VNF, in a case where SourceVIM and TargetVIM respectively exist in different networks, the WIM 130 is in charge of functionality linking SourceVIM-TargetVIM by VL (Virtual Link).

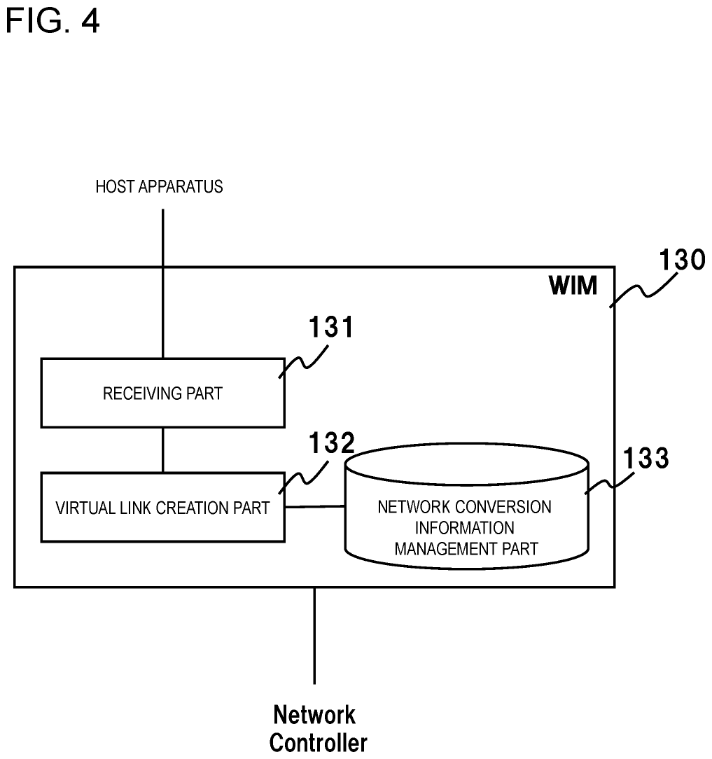

FIG. 4 is a functional block diagram showing a detailed configuration of the abovementioned WIM 130. Referring to FIG. 4, the WIM 130 is provided with a receiving part 131, a virtual link creation part 132 and a network conversion information management part 133.

As shown in FIG. 3, with regard to a VNF life cycle across a plurality of NFVi-PoPs existing in different networks, it is not possible to implement communication among VMs with a NFV standard configuration as it is. Therefore, in the present example embodiment, IDs of SourceVIM and TargetVIM are notified by the NFVO 100 to the WIM 130, and an instruction is given to create a network conversion table (below, referred to as NW conversion table) for networks (below referred to as VIM-NW) 201, 202, registered in respective VIMs of the SourceVIM and TargetVIM.

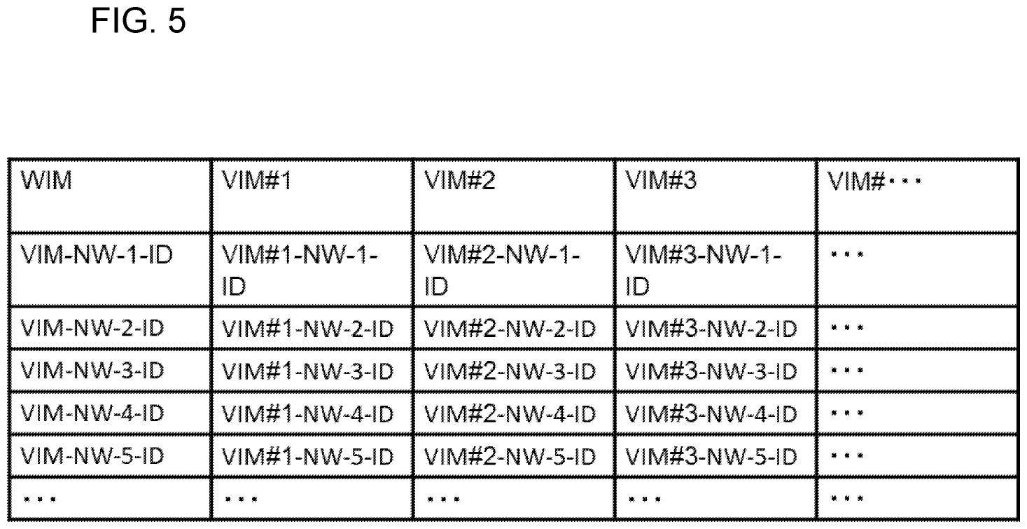

The receiving part 131 of the WIM 130 of FIG. 4 receives an instruction from the abovementioned NFVO 100. The virtual link creation part 132 creates an NW conversion table shown in FIG. 5, based on the instruction, to be stored in the network conversion information management part 133. The virtual link creation part 132 passes an entry of the created NW conversion table to Network Controllers 151-154 of a network containing the respective VIMs. The respective Network Controllers 151-154 that have received the entry perform routing between VIM-NWs registered in the respective VIMs. In this way, internal communication is possible between VMs controlled at VIMs of other networks within the VNF.

FIG. 5 shows the NW conversion table. The example of FIG. 5 shows entries associating address or VLAN information among VIM-NWs specified by VIM IDs VIM #1, #2, #3. It is to be noted that the example of FIG. 5 shows correspondence between 3 VIM-NWs, but the number of associated VIM-NWs is not limited to 3. For example, in a case where there are 2 VIMs as in FIG. 3, VIM-NW 201 of NFVI-PoP1 and VIM-NW 202 of NFVI-PoP2 are associated.

It is to be noted that in the example of FIG. 3, the WIM 130 and the Network Controller 154 are disposed independently, but the WIM 130 and the Network Controller 154 may be integrated. In this case, the WIM 130 has a function as an SDN (Software Defined Network) controller that controls the WAN (third network).

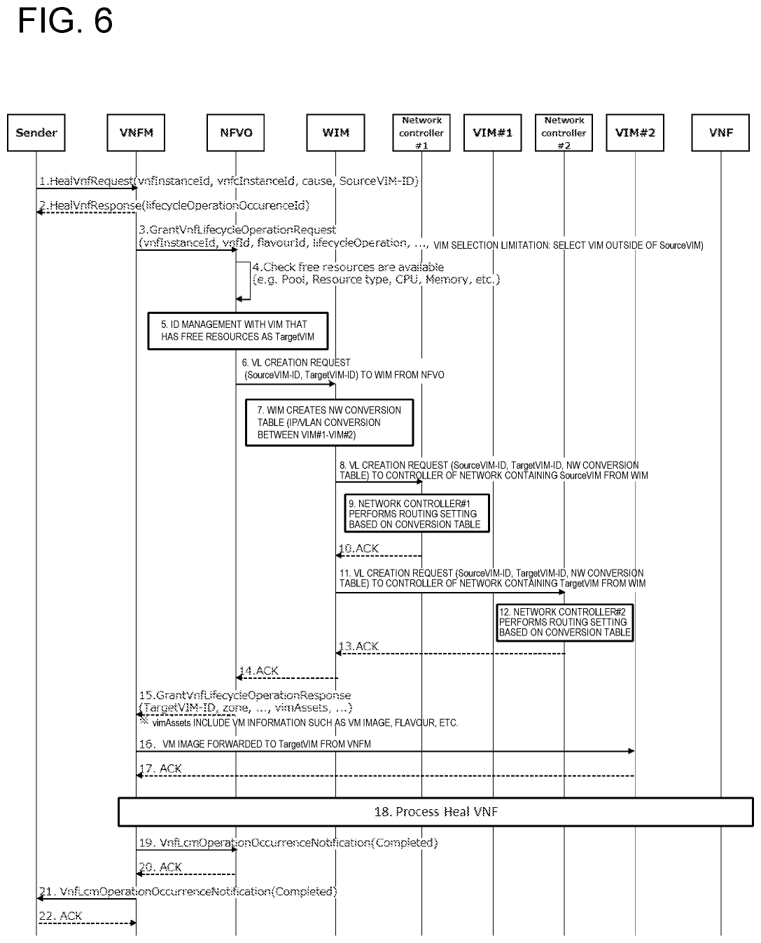

Next, a detailed description is given concerning operations of the present example embodiment, making reference to the drawings. In the following description, an example is cited in which Healing of VNF lifecycle is performed, under the control of the NFVO 100. FIG. 6 is a sequence diagram representing operations of the first example embodiment of the disclosure. VIM#1 in FIG. 6 is in a network managed by a Network Controller#1, and is a SourceVIM. VIM#2 is in a network managed by a Network Controller#2, and is a TargetVIM.

STEP 1: Sender gives an instruction for VNF Healing to the VNFM (VNFM 110 in FIG. 3). Here, the Sender indicates a maintenance agent or a host apparatus (for example, OSS/BSS or Orchestrator in FIG. 2). On this occasion, the Sender transmits a Healing request adding SourceVIM-ID to a parameter. This portion is different from the NFV standard.

STEP 2: The VNFM returns a response to the Sender.

STEP 3: The VNFM transmits a VNF Healing request to the NFVO (VNFM 110 in FIG. 3). On this occasion, the VNFM gives an instruction to add a TargetVIM selection limitation “select outside of SourceVIM” to a parameter of the NFV standard.

STEP 4: The NFVO retrieves a resource satisfying available resources and the TargetVIM selection limitation, by referring to information held by the NFVO.

Below, STEP 5-STEP 17 are different from the NFV standard. STEP 5: The NFVO, with a VIM that has a resource satisfying the available resources and the TargetVIM selection limitation as the TargetVIM, manages the VIM ID thereof.

STEP 6: The NFVO transmits a VL creation request (VL creation instruction) to a WIM (WIM 130 of FIG. 3). On this occasion, the NFVO transmits a VL creation request where SourceVIM-ID, TargetVIM-ID are set as parameters.

STEP 7: The WIM creates a VIM-NW conversion table associating VIM-NWs among the SourceVIMs and TargetVIMs, based on a VL creation request from the NFVO.

STEP 8: The WIM transmits the VL creation request to the Network Controller#1 (for example, Network Controller 151 or 152 in FIG. 3) of a network containing a SourceVIM. On this occasion, the WIM transmits a VL creation request where the SourceVIM-ID, TargetVIM-ID and content of a relevant entry of the NW conversion table are set, as parameters.

STEP 9: The Network Controller#1 performs routing setting with regard to VIM-NW between SourceVIM and TargetVIM, based on entries of the received NW conversion table.

STEP 10: The Network Controller#1 returns a response to the WIM.

STEP 11: The WIM transmits the VL creation request to the Network Controller#2 (for example, Network Controller 153 of FIG. 3) of a network containing TargetVIM. On this occasion, the WIM transmits a VL creation request where SourceVIM-ID, TargetVIM-ID and content of a relevant entry of the NW conversion table are set as parameters.

STEP 12: The Network Controller#2 performs routing setting for a VIM-NW among SourceVIM, TargetVIM, based on entries of the received NW conversion table.

STEP 13: The Network Controller#2 returns a response to the WIM.

STEP 14: The WIM returns a response to the NFVO.

STEP 15: The NFVO returns a GrantVnfLifecycleOperation response to the VNFM. On this occasion, the NFVO transmits a response setting TargetVIM-ID, VM image, flavor information and the like (vimAssets) as parameters.

STEP 16: The VNFM forwards a VM image that is a Healing target to the TargetVIM.

STEP 17: The TargetVIM returns a response to the VNFM.

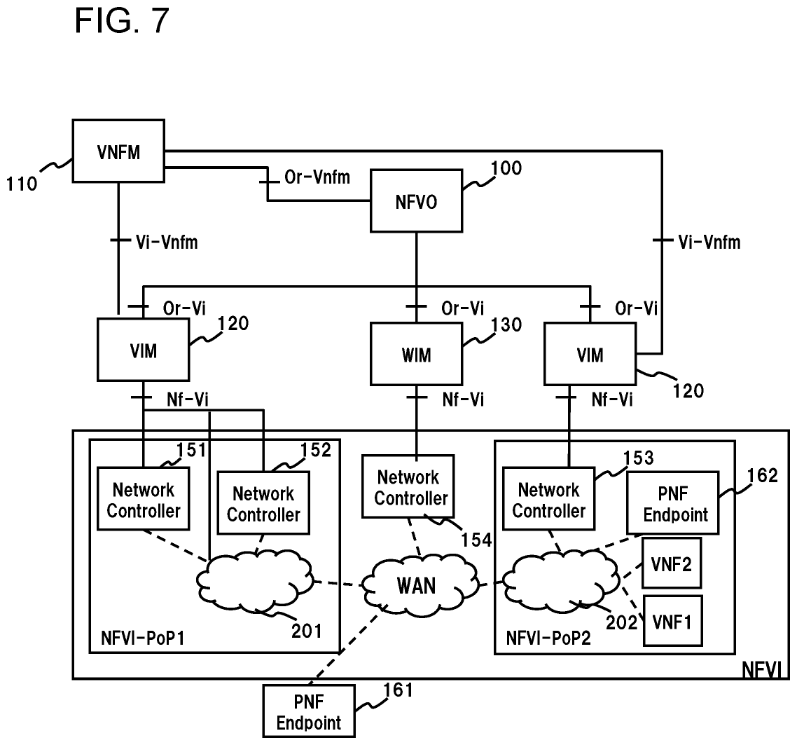

STEP 18: The VNFM gives an instruction to the TargetVIM to implement VM Healing. According to the above, a state occurs in which the VNF moves to the TargetVIM (refer to VNF1 in FIG. 7).

STEP 19: The VNFM sends a VNF lifecycle completion notification to the NFVO.

STEP 20: The NFVO returns a response to the VNFM.

STEP 21: The VNFM sends a VNF lifecycle completion notification to the Sender.

STEP 22: The Sender returns a response to the VNFM.

According to the above, a series of processes is completed. As is clear from the abovementioned description, in the present example embodiment it is possible to move all VMs on the NFVI managed by the SourceVIM to an NFVI managed by the TargetVIM. In this way, a SourceVIM upgrade is possible in a state without affecting service to the VNF due to SourceVIM NorthBound-Interface connection interruption (refer to reference point Vi-Vnfm, Nf-Vi in FIG. 2). In other words, this means that according to the present example embodiment, a creation request for a virtual link can be transmitted to the WIM 130, before VIM service is halted due to the abovementioned upgrade or the like, and the VNF can be moved to a another virtual infrastructure while continuing service.

### <Second Example Embodiment>

In the abovementioned first example embodiment, a description has been given in which a WIM 130 creates an entry of a VIM-NW conversion table on the occasion of a VL creation request (VL creation instruction) from a host apparatus, such as a VNFM or NFVO.

This example embodiment differs from the first example embodiment in the point of providing the VIM-NW conversion table in advance. In the present example embodiment, there is a difference from the first example embodiment in the point that the WIM 130 creates the VIM-NW conversion table in advance, for each VIM managed by the NFVO. Thus, it is possible to reduce a sequence when a VM moves between VIMs by 1 step. Since the configuration of the WIM and the like is the same as the first example embodiment, the description below is centered on points of difference therefrom.

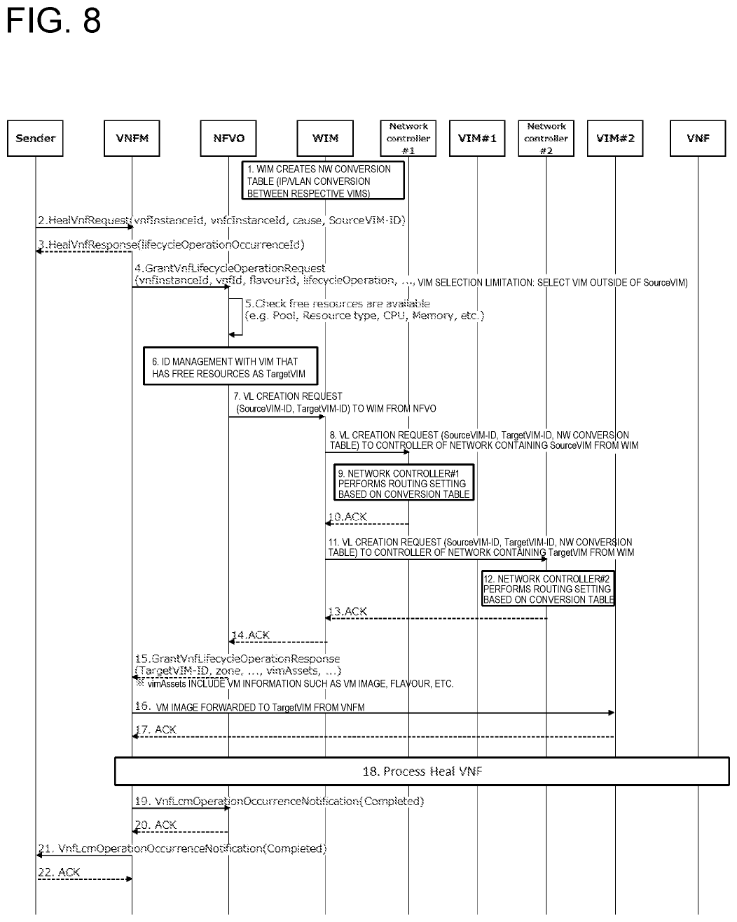

FIG. 8 is a sequence diagram representing operations of the second example embodiment of the disclosure. In the present example embodiment, the description cites an example of performing Healing in a VNF lifecycle. As in FIG. 6, VIM#1 in FIG. 8 is in a network managed by Network Controller#1, and is a SourceVIM. VIM#2 is in a network managed by Network Controller#2, and is a TargetVIM.

STEP 1: The WIM creates the VIM-NW conversion table for each VIM managed by the NFVO (refer to FIG. 5). This step constitutes a difference from the first example embodiment.

STEP 2: A Sender gives an instruction of VNF Healing to the VNFM. Similar to the first example embodiment, the Sender specifies a maintenance agent or a host apparatus. On this occasion, the Sender transmits a Healing request adding SourceVIM-ID to a parameter. This portion constitutes a difference from the NFV standard.

STEP 3: The VNFM returns a response to the Sender.

STEP 4: The VNFM transmits a VNF Healing request to the NFVO. On this occasion, the VNFM gives an instruction to add a TargetVIM selection limitation “select outside of SourceVIM” to a parameter of the NFV standard.

STEP 5: The NFVO retrieves a resource satisfying available resources and a TargetVIM selection limitation, making reference to information held by the NFVO.

Below, STEP 6-STEP 17 are different from the NFV standard. STEP 6: The NFVO, with a VIM that has a resource satisfying the available resources and the TargetVIM selection limitation, as the TargetVIM, manages the VIM ID thereof.

STEP 7: The NFVO transmits a VL creation request (VL creation instruction) to the WIM. On this occasion, the NFVO transmits a VL creation request where the SourceVIM-ID and TargetVIM-ID are set as parameters.

STEP 8: The WIM transmits the VL creation request to Network Controller#1 (for example, Network Controller 151 or 152 of FIG. 3) of a network containing SourceVIM. On this occasion, the WIM transmits a VL creation request where SourceVIM-ID and TargetVIM-ID and content of a relevant entry of the NW conversion table are set as parameters.

STEP 9: The Network Controller#1 performs routing for a VIM-NW between SourceVIM and TargetVIM, based on entries of the received NW conversion table.

STEP 10: The Network Controller#1 returns a response to the WIM.

STEP 11: The WIM transmits the VL creation request to the Network Controller#2 (for example, the Network Controller 153 of FIG. 3) of a network containing the TargetVIM. On this occasion, the WIM transmits a VL creation request where the SourceVIM-ID, TargetVIM-ID and content of relevant entries of the NW conversion table are set as parameters.

STEP 12: The Network Controller#2 performs routing setting for the VIM-NW between the SourceVIM and TargetVIM, based on entries of the received NW conversion table.

STEP 13: The Network Controller#2 returns a response to the WIM.

STEP 14: The WIM returns a response to the NFVO.

STEP 15: The NFVO returns a GrantVnfLifecycleOperation response to the VNFM. On this occasion, the NFVO transmits a response setting TargetVIM-ID, VM image, flavor information and the like (vimAssets) as parameters.

STEP 16: The VNFM forwards a VM image that is a Healing target to a TargetVIM.

STEP 17: The TargetVIM returns a response to the VNFM.

STEP 18: The VNFM gives an instruction to the TargetVIM to implement VM Healing. According to the above, a state occurs in which the VNF moves to the TargetVIM (refer to VNF1 in FIG. 7).

STEP 19: The VNFM sends a VNF lifecycle completion notification to the NFVO.

STEP 20: The NFVO returns a response to the VNFM.

STEP 21: The VNFM sends a VNF lifecycle completion notification to the Sender.

STEP 22: The Sender returns a response to the VNFM.

As described above, according to the second example embodiment, it is possible to reduce processing steps after a VL creation request by 1, in comparison with the first example embodiment.

### <Third Example Embodiment>

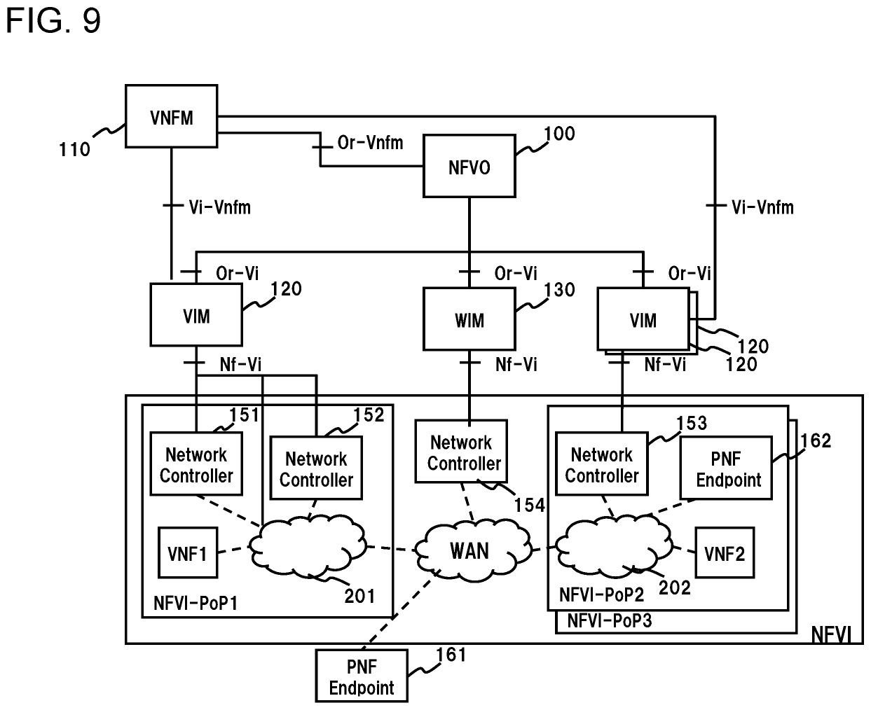

In the first and second example embodiments described above, a description was given citing examples where there is 1 TargetVIM, but there may also be 2 or more TargetVIMs (refer to FIG. 9). Below, a description is given concerning a third example embodiment, assuming there are 2 TargetVIMs. It is to be noted that since the configuration of the WIM and the like is the same as the first and second example embodiments, the description below is centered on points of difference therefrom.

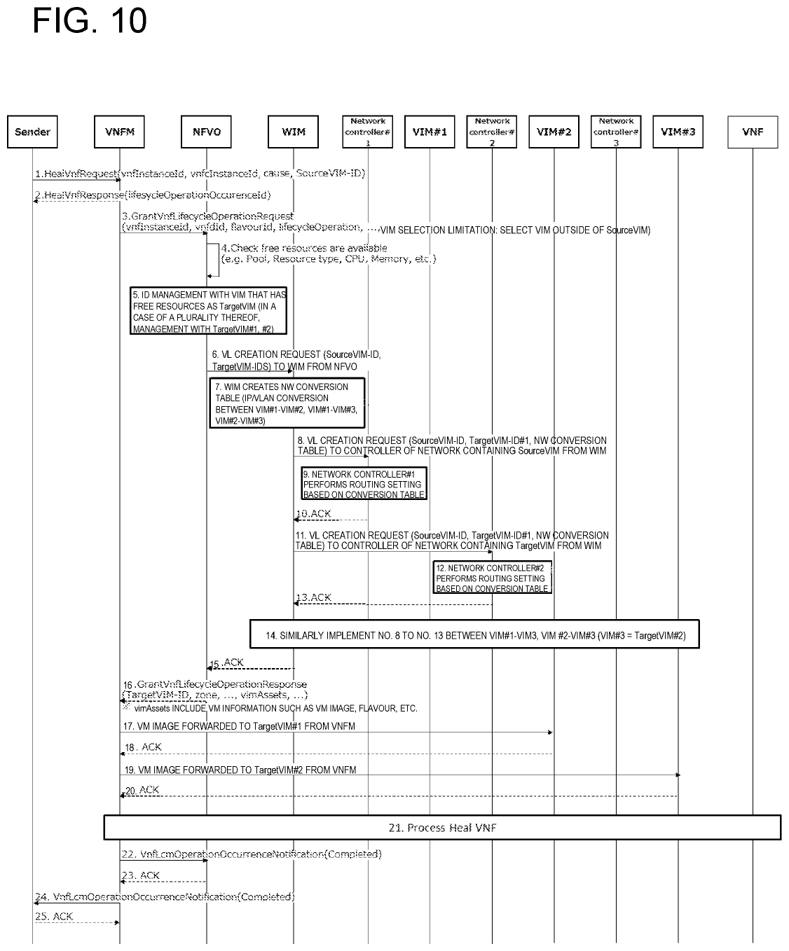

FIG. 10 is a sequence diagram representing operations of the third example embodiment of the present disclosure. In the present example embodiment, the description cites an example of performing Healing in a VNF lifecycle. As in FIG. 6 and FIG. 8, VIM#1 in FIG. 10 is in a network managed by Network Controller#1, and is a SourceVIM. VIM#2 is in a network managed by Network Controller#2, and below is taken as TargetVIM#1. VIM#3 is in a network managed by Network Controller#3, and below is taken as TargetVIM#2.

STEP 1: A Sender gives an instruction of VNF Healing to a VNFM. Similar to the first example embodiment, the Sender specifies a maintenance agent or a host apparatus. On this occasion, the Sender transmits a Healing request adding SourceVIM-ID to a parameter. This portion constitutes a difference from the NFV standard.

STEP 2: The VNFM returns a response to the Sender.

STEP 3: The VNFM transmits a VNF Healing request to the NFVO.

On this occasion, the VNFM gives an instruction to add a TargetVIM selection limitation “select outside of SourceVIM” to a parameter of the NFV standard.

STEP 4: The NFVO retrieves a resource satisfying available resources and the TargetVIM selection limitation, making reference to information held by the NFVO.

STEP 5: The NFVO, with a VIM that has an available resource as a TargetVIM, manages a VIM ID thereof. In the present example embodiment, 2 VIMs having available resources are selected. The NFVO performs management with these as TargetVIM#1-ID and TargetVIM#2-ID.

STEP 6: The NFVO transmits a VL creation request (VL creation instruction) to the WIM. On this occasion, the NFVO transmits a VL creation request where the SourceVIM-ID, TargetVIM-ID are set as parameters.

STEP 7: The WIM creates a VIM-NW conversion table between SourceVIM-TargetVIM#1 and between SourceVIM-TargetVIM#2, and between TargetVIM#1-TargetVIM#2, based on a VL creation request from the NFVO.

STEP 8: The WIM transmits the VL creation request to Network Controller#1 of a network containing a SourceVIM. On this occasion, the WIM transmits the VL creation request where SourceVIM-ID, TargetVIM-ID, and content of relevant entries of the NW conversion table are set as parameters.

STEP 9: The Network Controller#1 performs routing setting regarding VIM-NW among SourceVIM and TargetVIM, based on an entry of the received NW conversion table.

STEP 10: The Network Controller#1 returns a response to the WIM.

STEP 11: The WIM transmits the VL creation request to the Network Controller#2 of a network containing a TargetVIM. On this occasion, the WIM transmits the VL creation request where SourceVIM-ID, TargetVIM-ID, and content of relevant entries of the NW conversion table are set as parameters.

STEP 12: The Network Controller#2 performs routing setting for VIM-NW between SourceVIM and TargetVIM, based on an entry of the received NW conversion table.

STEP 13: The Network Controller#2 returns a response to the WIM.

STEP 14: Processing similar to STEP 8-STEP 13 is similarly carried out between SourceVIM-TargetVIM#2 and TargetVIM#1-TargetVIM#2.

STEP 15: The WIM returns a response to the NFVO.

STEP 16: The NFVO returns a GrantVnfLifecycleOperation response to the VNFM. On this occasion, the NFVO transmits a response where TargetVIM-ID, VM image flavor information and the like (vimAssets) are set as parameters.

STEP 17: The VNFM forwards a VM image that is a Healing target to a TargetVIM #1.

STEP 18: TargetVIM #1 returns a response to the VNFM.

STEP 19: A VM image that is a Healing target is forwarded from the VNFM to TargetVIM #2.

STEP 20: TargetVIM #2 returns a response to the VNFM.

STEP 21: The VNFM gives an instruction to the TargetVIMs #1, #2 to implement VM Healing. From the above, a state occurs where VNF is configured by VMs of TargetVIM #1, #2.

STEP 22: The VNFM sends a VNF lifecycle completion notification to the NFVO.

STEP 23: The NFVO returns a response to the VNFM.

STEP 24: VNFM sends a VNF lifecycle completion notification to the Sender.

STEP 25: The Sender returns a response to the VNFM.

As described above, according to the third example embodiment, it is possible to cause the VNF operating on a virtual infrastructure managed by a certain VIM to move using a plurality of VIMs.

A description has been given above of respective example embodiments of the present disclosure, but the present disclosure is not limited to the abovementioned example embodiments, and further modifications, substitutions and adjustments may be added within a scope that does not depart from fundamental technical concepts of the disclosure. For example, network configurations, respective element configurations and message expression modes shown in the respective drawings are examples for the purpose of aiding understanding of the disclosure, and are not intended to limit the disclosure to configurations illustrated in the drawings. In the following description, “A and/or B” is used to indicate at least one of A or B.

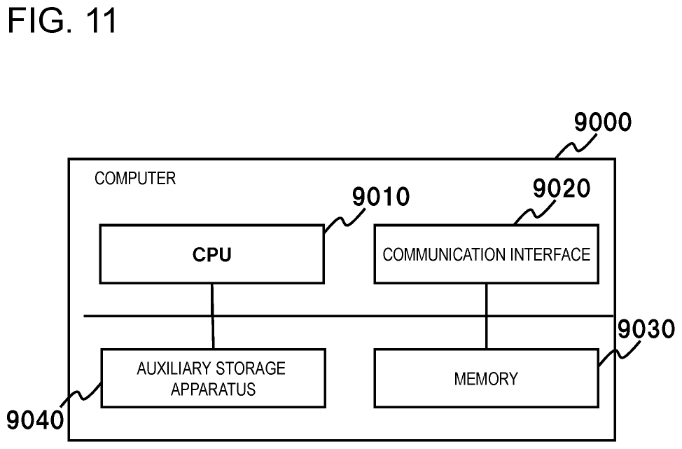

The WIM in the abovementioned first to third example embodiments may be realized by a program that causes a computer functioning as the WIM 130 (9000 in FIG. 11) to realize functionality as the WIM 130. Such a computer is exemplified in a configuration provided with a CPU (Central Processing Unit) 9010, a communication interface 9020, a memory 9030, and an auxiliary storage apparatus 9040, in FIG. 11. Namely, a domain decomposition program or a position estimation program may be executed in the CPU 9010 of FIG. 11, and update processing of respective calculation parameters held in the auxiliary storage apparatus 9040 may be implemented.

That is, the respective parts (processing means, functions) of the abovementioned WIM 130 illustrated in the abovementioned first to third example embodiments may be implemented by a computer program that causes the abovementioned respective processing to be executed in a processor installed in the WIM 130, using hardware thereof.

Finally, preferred modes of the present disclosure are summarized.

### <First Mode>

(Refer to the management apparatus according to the first aspect described above.)

### <Second Mode>

The network conversion information management part of the management apparatus may adopt a configuration that creates the network conversion information, based on the creation instruction for the virtual link from the host apparatus.

### <Third Mode>

The host apparatus of the management apparatus, after giving the creation instruction for the virtual link, may cause a virtual machine configuring a virtual network function operating on the first virtual infrastructure, to move to the second virtual infrastructure, and implement healing.

### <Fourth Mode>

The management apparatus, wherein a configuration may be adopted in which there exist at least 2 of the second virtual infrastructures that are movement destinations of the virtual network function, and a virtual link is created that connects the first virtual infrastructure and each of the at least 2 second virtual infrastructures.

### <Fifth Mode>

The management apparatus preferably has a function as an SDN (Software Defined Network) controller that controls the third network.

### <Sixth Mode>

The host apparatus may have an NFV orchestrator (NFVO) or a virtual network function manager (VNFM).

### <Seventh Mode>

(Refer to the host apparatus according to the second aspect described above.)

### <Eighth Mode>

(Refer to the management method according to the third aspect described above.)

### <Ninth Mode>

(Refer to the program according to the fourth aspect described above.) It is to be noted that the abovementioned seventh to ninth modes may be expanded with regard to the second to sixth modes, similar to the first mode.

It is to be noted that the various disclosures of the abovementioned Patent Literature and Non-Patent Literature are incorporated herein by reference thereto. Modifications and adjustments of example embodiments and examples may be made within the bounds of the entire disclosure (including the scope of the claims) of the present disclosure, and also based on fundamental technological concepts thereof. Various combinations and selections (including partial removals) of various disclosed elements (including respective elements of the respective claims, respective elements of the respective example embodiments and examples, respective elements of the respective drawings and the like) are possible within the scope of the disclosure of the present disclosure. That is, the present disclosure clearly includes every type of transformation and modification that a person skilled in the art can realize according to the entire disclosure including the scope of the claims and to technological concepts thereof. In particular, with regard to numerical ranges described in the present specification, arbitrary numerical values and small ranges included in the relevant ranges should be interpreted to be specifically described even where there is no particular description thereof.

### REFERENCE SIGNS LIST

10 management apparatus
11 receiving part
12 virtual link creation part
13 network conversion information management part
21, 22 network management apparatus
2 NFVO
110 VNFM
120 VIM
130 WIM
131 receiving part
132 virtual link creation part
133 network conversion information management part
151, 152, 153, 154 Network Controller
161, 162 PNF Endpoint
201, 202 network
9000 computer
9010 CPU
9020 communication interface
9030 memory
9040 auxiliary storage apparatus

1. A management apparatus comprising:
a receiving part configured to receive, from a host apparatus, a creation instruction for a virtual link that connects a first virtual infrastructure on which a virtual network function is operating and a second virtual infrastructure that is a movement destination of the virtual network function;
a network conversion information management part configured to manage network conversion information for connecting a first network built on the first virtual infrastructure and a second network built on the second virtual infrastructure, via a third network; and
a virtual link creation part configured to transmit, based on the creation instruction for the virtual link, the network conversion information to network management apparatuses that respectively manage the first and second networks, and causes the network management apparatuses to create a virtual link which realizes communication between virtual machines configuring the virtual network function across the first and second virtual infrastructures.

2. The management apparatus according to claim 1, wherein the network conversion information management part creates the network conversion information, based on the creation instruction for the virtual link from the host apparatus.

3. The management apparatus according to claim 1, wherein the host apparatus, after giving the creation instruction for the virtual link, causes a virtual machine configuring a virtual network function operating on the first virtual infrastructure, to move to the second virtual infrastructure, to implement healing.

4. The management apparatus according to claim 1, wherein there exist at least 2 of the second virtual infrastructures that are movement destinations of the virtual network function, and a virtual link is created that connects the first virtual infrastructure and each of the at least 2 second virtual infrastructures.

5. The management apparatus according to claim 1, comprising a function as an SDN (Software Defined Network) controller that controls the third network.

6. The management apparatus according to claim 1, wherein the host apparatus is an NFV orchestrator or a virtual network function manager.

7. A host apparatus that, before halting service of a virtual infrastructure management part managing the first virtual infrastructure, transmits a creation instruction for the virtual link to the management apparatus of claim 1, and causes a virtual machine configuring a virtual network function operating on the first virtual infrastructure, to move to the second virtual infrastructure, to implement healing.

8. The host apparatus according to claim 7 wherein, in a case where there exist at least 2 of the second virtual infrastructures that are movement destinations of the virtual network function, a creation instruction is given for a virtual link connecting the first virtual infrastructure and each of the at least 2 second virtual infrastructures, to the management apparatus.

9. A management method in a management apparatus that includes a network conversion information management part that manages network conversion information for connecting a first network built on a first virtual infrastructure and a second network built on a second virtual infrastructure, via a third network, the method comprising:
receiving, from a host apparatus, a creation instruction for a virtual link that connects a first virtual infrastructure on which a virtual network function is operating and a second virtual infrastructure that is a movement destination of the virtual network function; and
transmitting, based on the creation instruction for the virtual link, the network conversion information to network management apparatuses that respectively manage the first and second networks, and causing the network management apparatuses to create a virtual link which realizes communication between virtual machines configuring the virtual network function across the first and second virtual infrastructures.

10. (canceled)

11. The management apparatus according to claim 2, wherein the host apparatus, after giving the creation instruction for the virtual link, causes a virtual machine configuring a virtual network function operating on the first virtual infrastructure, to move to the second virtual infrastructure, to implement healing.

12. The management apparatus according to claim 2, wherein there exist at least 2 of the second virtual infrastructures that are movement destinations of the virtual network function, and a virtual link is created that connects the first virtual infrastructure and each of the at least 2 second virtual infrastructures.

13. The management apparatus according to claim 3, wherein there exist at least 2 of the second virtual infrastructures that are movement destinations of the virtual network function, and a virtual link is created that connects the first virtual infrastructure and each of the at least 2 second virtual infrastructures.

14. The management apparatus according to claim 2, comprising a function as an SDN (Software Defined Network) controller that controls the third network.

15. The management apparatus according to claim 3, comprising a function as an SDN (Software Defined Network) controller that controls the third network.

16. The management apparatus according to claim 4, comprising a function as an SDN (Software Defined Network) controller that controls the third network.

17. The management apparatus according to claim 2, wherein the host apparatus is an NFV orchestrator or a virtual network function manager.

18. The management apparatus according to claim 3, wherein the host apparatus is an NFV orchestrator or a virtual network function manager.

19. The management apparatus according to claim 4, wherein the host apparatus is an NFV orchestrator or a virtual network function manager.
